(19) United States
(12) Patent Application Publication
(10) Pub. No.: US 2019/0347425 A1
(43) Pub. Date: Nov. 14, 2019

(54) METHOD AND APPARATUS FOR IDENTITY AUTHENTICATION

(71) Applicant: Alibaba Group Holding Limited, George Town (KY)

(72) Inventors: Kun Yu, Hangzhou (CN); Yan Wang, Beijing (CN)

(21) Appl. No.: 16/421,294

(22) Filed: May 23, 2019

Related U.S. Application Data
(63) Continuation-in-part of application No. PCT/CN2017/111506, filed on Nov. 17, 2017.

(30) Foreign Application Priority Data
Nov. 30, 2016 (CN) 201611089354.3

(51) Int. Cl. G06F 21/57; G06F 21/31; G06F 21/32

(52) U.S. Cl. CPC G06F 21/577; G06F 21/32; G06F 21/316

(57) ABSTRACT

Identity authentication is disclosed including collecting multiple types of information about a user awaiting identity authentication, the multiple types of information being used to authenticate the identity of the user, acquiring a plurality of risk coefficients corresponding to respective ones of the multiple types of information, a risk coefficient among the plurality of risk coefficients indicating a degree to which the user's identity is trusted, obtaining a comprehensive risk coefficient based at least in part on the plurality of risk coefficients corresponding to the respective ones of the multiple types of information, and determining whether to authenticate the user's identity based at least in part on the comprehensive risk coefficient.

### CROSS REFERENCE TO OTHER APPLICATIONS

This application is a continuation-in-part of and claims priority to International (PCT) Application No. PCT/CN2017/111506, entitled IDENTITY AUTHENTICATION METHOD AND APPARATUS, AND COMPUTING DEVICE, filed Nov. 17, 2017 which is incorporated herein by reference for all purposes, which claims priority to China Application No. 201611089354.3, entitled AN IDENTITY AUTHENTICATION METHOD AND MEANS AND A COMPUTING DEVICE, filed Nov. 30, 2016 which is incorporated herein by reference for all purposes.

### FIELD OF THE INVENTION

The present invention relates to a method and a system for identity authentication.

### BACKGROUND OF THE INVENTION

Identity authentication is also called “identity verification” or “identification.” Identity authentication refers to a process of confirming an operator's identity or a user's identity on a computer or a computer network system and thereby determines whether the user is authorized to access and use certain resources. Identity authentication thus enables reliable and effective execution of computer and network system access strategies and prevents hackers from faking as legitimate users to obtain access rights to resources. Identity authentication provides system and data security, and the legitimate rights and interests of authorized visitors. Internet identity authentication typically includes identifying a user based on identity authentication conditions and authorizing a user who has satisfied all of the identity authentication conditions. For example, an identity authentication condition is identity card information, and authentication of a user's identity is determined based on the identity card information that was input. In another example, an identity authentication condition is a user's facial information, and authentication of a user's identity can be determined based on the user's facial information. In typical identity authentication systems employing multiple identity authentication conditions, each authentication condition-based decision regarding identity authentication of a user's identity is mutually independent. No relationship exists between the authentication condition-based decisions. Therefore, there is a greater risk of error during identity authentication decision-making because multiple conditions/decisions can go wrong. Having a greater risk of error is detrimental to user experience.

### SUMMARY OF THE INVENTION

The present application provides a process for identity authentication, a system for identity authentication, and a computing device for identity authentication to address the issue that each authentication condition-based decision for authenticating a user's identity is mutually independent, without any relationship between the various decisions, which can result in a greater risk of error during identity authentication decision-making, which is detrimental to user experience.

In some embodiments, a process for identity authentication is provided. This process comprises: collecting multiple types of information on the user awaiting identity authentication, wherein the multiple types of information are used to authenticate a user's identity; acquiring a risk coefficient corresponding to each of the multiple types of information, wherein the risk coefficient indicates a degree to which the user's identity is trusted (e.g., if the user is who he/she claims to be); obtaining a comprehensive risk coefficient by conducting a comprehensive evaluation of the risk coefficients corresponding to each type of information; and determining whether to authenticate the user's identity based on the comprehensive risk coefficient.

In some embodiments, a system for identity authentication is provided. This system comprises: a collecting unit configured to collect multiple types of information on the user awaiting identity authentication, wherein the multiple types of information are used to authenticate a user's identity; a first acquiring unit configured to acquire a risk coefficient corresponding to each of the multiple types of information, wherein the risk coefficient indicates a degree to which the user's identity is trusted; a second acquiring unit configured to obtain a comprehensive risk coefficient by conducting a comprehensive evaluation of the risk coefficients corresponding to each type of information; and a determining unit configured to determine whether to authenticate the user's identity based on the comprehensive risk coefficient.

A computing device including a first interface for user interaction is disclosed. The first interface includes a plurality of first controls, the plurality of first controls configured to collect multiple types of information on the user awaiting identity authentication, the multiple types of information being used for authenticating a user's identity; a first sending unit configured to send the multiple types of information to a server, the server being configured to evaluate the risk coefficients of the multiple types of information to obtain a comprehensive risk coefficient, wherein a risk coefficient indicates a degree to which the user's identity is trusted; a second receiving unit configured to receive, from the server, risk coefficients corresponding to the multiple types of information and the comprehensive risk coefficient; a plurality of second controls corresponding to the plurality of first controls configured to generate the risk coefficients corresponding to each type of information; and a third control configured to generate the comprehensive risk coefficient for the user awaiting identity authentication.

In some embodiments, authenticating a user's identity based on the multiple types of information is performed by: collecting the multiple types of information on the user awaiting identity authentication, wherein the multiple types of information are used to authenticate a user's identity; acquiring a risk coefficient corresponding to each of the multiple types of information, wherein the risk coefficient indicates a degree to which the user's identity is trusted; obtaining a comprehensive risk coefficient by conducting a comprehensive evaluation of the risk coefficients corresponding to each type of information; and determining whether to authenticate the user's identity based on the comprehensive risk coefficient. This approach thus avoids a greater risk of error during identity authentication decision-making by associating the risk coefficients corresponding to each type of information and avoiding mutually independent and unassociated identity authentication. The approach thereby increases user identity authentication accuracy.

### BRIEF DESCRIPTION OF THE DRAWINGS

Various embodiments of the invention are disclosed in the following detailed description and the accompanying drawings.

The drawings described here are intended to further the understanding of the present invention and form a part of the present application. The illustrative embodiments of the present invention and the descriptions thereof are intended to explain the present invention and do not constitute inappropriate limitation of the present invention. Among the drawings:

FIG. 1 is a functional diagram illustrating a programmed computer system for executing identity authentication in accordance with some embodiments.

FIG. 2 is a flowchart of an embodiment of a process for identity authentication.

FIG. 3 is a flowchart of an embodiment of a process for obtaining a comprehensive risk coefficient.

FIG. 4 is a flowchart of another embodiment of a process for obtaining a comprehensive risk coefficient.

FIG. 5 is a flowchart of an embodiment of a process for acquiring a risk coefficient corresponding to each type of information.

FIG. 6 is a diagram of another embodiment of a process for identity authentication.

FIG. 7 is a diagram of yet another embodiment of a process for identity authentication.

FIG. 8A is a diagram of an embodiment of a device for identity authentication.

FIG. 8B is a diagram of an embodiment of an acquiring unit module.

FIG. 8C is a diagram of another embodiment of an acquiring unit module.

FIG. 9A is a diagram of an embodiment of a system for identity authentication.

FIG. 9B is a diagram of an embodiment of a first control.

FIG. 10 is a diagram of an embodiment of a system for identity authentication.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

In some embodiments, the present invention provides a process for identity authentication. The process for identity authentication can be used in identity authentication of a user on the Internet. For example, after a user registers with a finance-related application (app), in order to use the finance-related app, it is necessary to confirm the user's identity. In the event that the user uploads a picture, determining whether the photo corresponds to the user based on an uploaded self-taken photo is not possible. The uploaded self-taken photo will not be regarded as the photo corresponding to the user because the user could have downloaded a photo from the Internet for the purpose of impersonation. This kind of risk can be reduced if multiple types of information relating to the user are collected. In the event that multiple types of information relating to the user are collected, a comprehensive risk coefficient can be obtained by comprehensively evaluating a risk coefficient corresponding to each type of information. Determining whether to authenticate the user's identity based on the comprehensive risk coefficient can occur.

The process can be implemented on an app installed on a mobile terminal. In other words, a mobile terminal app can determine whether to authenticate a user's identity.

The process can also be implemented on a server. For example, an app or software can serve as an interface to acquire photos. A user can upload the photos via the app or software. Then the app or software can send the photos to the server, which assesses the photos. A server's computing capability is more powerful than the computing capability of the app itself. Therefore, a large quantity of photos from different apps or software can be simultaneously processed by the server. The server can be a true hardware server, or the server can be a service. With the development of cloud computing, such services can be located with other cloud services and provide processing.

Regardless of whether the process is implemented on a terminal or a server, the identification result can be used by other apps or services. In summary, user identity authentication based on multiple types of information used to authenticate a user's identity can be implemented in various kinds of situations, which will not be further discussed here for conciseness.

A description is to be provided regarding the structure of a mobile terminal, computer, server, or other hardware of the present application. The hardware structure discussed below is a hardware structure which is currently in wide use. As technology develops, these hardware structures are to change. So long as the above process can be implemented, the process can determine whether to authenticate a user's identity, regardless of the kind hardware structure present.

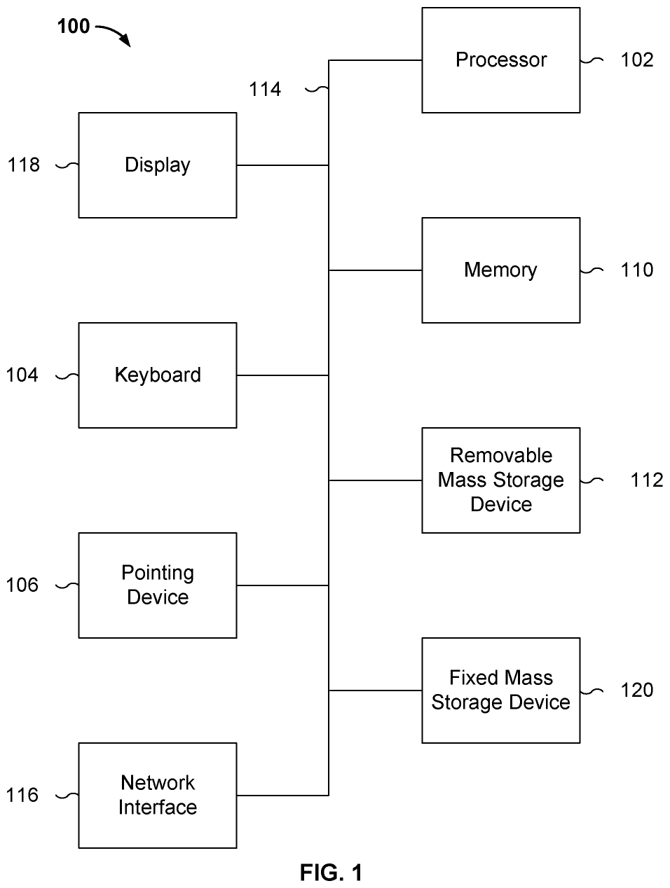

FIG. 1 is a functional diagram illustrating a programmed computer system for executing identity authentication in accordance with some embodiments. As will be apparent, other computer system architectures and configurations can be used to perform identity authentication. Computer system 100, which includes various subsystems as described below, includes at least one microprocessor subsystem (also referred to as a processor or a central processing unit (CPU)) 102. For example, processor 102 can be implemented by a single-chip processor or by multiple processors. In some embodiments, processor 102 is a general purpose digital processor that controls the operation of the computer system 100. Using instructions retrieved from memory 110, the processor 102 controls the reception and manipulation of input data, and the output and display of data on output devices (e.g., display 118).

Processor 102 is coupled bi-directionally with memory 110, which can include a first primary storage, typically a random access memory (RAM), and a second primary storage area, typically a read-only memory (ROM). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 102. Also as is well known in the art, primary storage typically includes basic operating instructions, program code, data and objects used by the processor 102 to perform its functions (e.g., programmed instructions). For example, memory 110 can include any suitable computer-readable storage media, described below, depending on whether, for example, data access needs to be bi-directional or uni-directional. For example, processor 102 can also directly and very rapidly retrieve and store frequently needed data in a cache memory (not shown).

A removable mass storage device 112 provides additional data storage capacity for the computer system 100, and is coupled either bi-directionally (read/write) or uni-directionally (read only) to processor 102. For example, storage 112 can also include computer-readable media such as magnetic tape, flash memory, PC-CARDS, portable mass storage devices, holographic storage devices, and other storage devices. A fixed mass storage 120 can also, for example, provide additional data storage capacity. The most common example of mass storage 120 is a hard disk drive. Mass storages 112, 120 generally store additional programming instructions, data, and the like that typically are not in active use by the processor 102. It will be appreciated that the information retained within mass storages 112 and 120 can be incorporated, if needed, in standard fashion as part of memory 110 (e.g., RAM) as virtual memory.

In addition to providing processor 102 access to storage subsystems, bus 114 can also be used to provide access to other subsystems and devices. As shown, these can include a display monitor 118, a network interface 116, a keyboard 104, and a pointing device 106, as well as an auxiliary input/output device interface, a sound card, speakers, and other subsystems as needed. For example, the pointing device 106 can be a mouse, stylus, track ball, or tablet, and is useful for interacting with a graphical user interface.

The network interface 116 allows processor 102 to be coupled to another computer, computer network, or telecommunications network using a network connection as shown. For example, through the network interface 116, the processor 102 can receive information (e.g., data objects or program instructions) from another network or output information to another network in the course of performing method/process steps. Information, often represented as a sequence of instructions to be executed on a processor, can be received from and outputted to another network. An interface card or similar device and appropriate software implemented by (e.g., executed/performed on) processor 102 can be used to connect the computer system 100 to an external network and transfer data according to standard protocols. For example, various process embodiments disclosed herein can be executed on processor 102, or can be performed across a network such as the Internet, intranet networks, or local area networks, in conjunction with a remote processor that shares a portion of the processing. Additional mass storage devices (not shown) can also be connected to processor 102 through network interface 116.

An auxiliary I/O device interface (not shown) can be used in conjunction with computer system 100. The auxiliary I/O device interface can include general and customized interfaces that allow the processor 102 to send and, more typically, receive data from other devices such as microphones, touch-sensitive displays, transducer card readers, tape readers, voice or handwriting recognizers, biometrics readers, cameras, portable mass storage devices, and other computers.

The computer system shown in FIG. 1 is but an example of a computer system suitable for use with the various embodiments disclosed herein. Other computer systems suitable for such use can include additional or fewer subsystems. In addition, bus 114 is illustrative of any interconnection scheme serving to link the subsystems. Other computer architectures having different configurations of subsystems can also be utilized.

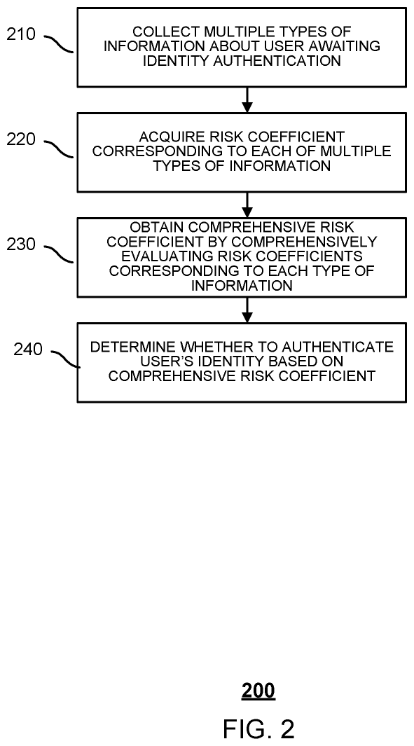

FIG. 2 is a flowchart of an embodiment of a process for identity authentication. In some embodiments, the process 200 is implemented by a computer terminal 100 of FIG. 1 and comprises:

In 210, the computer terminal collects multiple types of information about the user awaiting identity authentication. In some embodiments, the multiple types of information are used to authenticate the user's identity.

Authenticating the identity of a user on the Internet is required in many cases. In some embodiments, to authenticate the user's identity of a user having an identity that is awaiting authentication, multiple types of information for authenticating the identity of the user are collected.

For example, User A (the user to be authenticated), seeking to open a real-name account on a website, is to have their identity authenticated on the Internet. The website is to authorize User A and open a real-name account for User A only after User A's identity has been authenticated. Typically, User A can upload some User A-related materials for the purpose of identity authentication on the Internet. In the event that some User A-related materials are uploaded to the Internet to authenticate User A's identity, information is to be collected from the User A-related materials, and this information is to include information for authenticating the identity of User A. Collecting information from the Internet that can be used to authenticate User A's identity is possible. In the event that no User A-related materials are uploaded, then information from the Internet that can be used to authenticate User A's identity can be collected.

In some embodiments, the types of user information includes: identifying document information, biometric information, permission information, user Internet behavior information, or any combination thereof.

Using User A as an example again, the uploaded related materials include User A's identifying documents, User A's biometric information, or both. The information includes identifying document information from the uploaded identifying documents, biometric information from the uploaded User biometric information, or both.

Permission information about User A on the Internet can be used. For example, a determination is made as to whether User A is on an Internet blacklist established by the website or other authorities. In the event that User A is on an Internet blacklist, then User A's rights on the Internet are to be restricted.

Information about User A's behavior on the Internet can be User A's trail (history) of sites visited on the Internet. For example, User A's site visit trail on the Internet can be used to determine whether User A's operations on the Internet are risky.

In 220, the computer terminal acquires a risk coefficient corresponding to each of the multiple types of information. In some embodiments, the risk coefficient indicates a degree to which a user's identity is trusted. Risk coefficients can be evaluated positively. In this case, the larger the coefficient value is, the higher the degree to which the user's identity is trusted and the lower the risk following authentication of the user's identity. Risk coefficients can also be evaluated negatively. In this case, the larger the coefficient value is, the lower the degree to which the user's identity is trusted and the higher the risk following authentication of the user's identity.

Many types of user information can exist. In some embodiments, the types of user information include: identifying document information, biometric information, permission information, user Internet behavior information, or any combination thereof. Among these types of information, the information about the user's behavior on the Internet can be one option. User behavior information can also serve as a reference for evaluating the user, as explained below.

Among the types of information, identifying document information can be another option. Evaluation of the identifying document information can be multi-dimensional. For example, the risk coefficient corresponding to the identifying document information is determined based on: identifying document clarity, identifying document completeness, identifying document validity, or any combination thereof. Identifying document clarity can be used to determine whether a document was downloaded from the Web and is not an identifying document photograph taken by the user. Identifying document completeness can be used for a comprehensive evaluation. For example, an identity card photograph alone is sufficient to verify that an identity photograph uploaded by the user is their own. If the user uploads an identity card and a driver's license, the risk of user deception decreases significantly. The validity of the identifying document can be used to verify whether an identifying document is still valid. This is also helpful in determining the risk of user deception. It is understood that the identifying document information is not limited to the above examples. As long as it is possible to evaluate user risk coefficients, the types of identifying document information described above can be used either singly or in combination.

In various embodiments, the risk coefficients can be coefficient values or probabilities indicating the degree of trust associated with the corresponding users.

For example, using the example of User A to identifying document clarity, the risk coefficient is determined based on the clarity of the identifying document uploaded by User A. As expressed in terms of probability, 100% means that the user's identifying document photograph is clear and entirely risk-free. Photograph clarity can be defined using photograph parameters, such as photograph pixels and photograph size. Existing photograph clarity algorithms can be applied and will not be further discussed for conciseness. In the event that the clarity of the uploaded identifying document is 80% (e.g., the size of the photo is 80% of a threshold size), then the probability that the uploaded identifying document is to be found acceptable is 80%, and the risk coefficient determined based on the probability of document acceptability is 80%. In some embodiments, the clarity of the identifying document is based on the probability of successfully recognizing information in the identifying document. In some embodiments, the risk coefficient corresponds to the probability that the identifying document is unacceptable. In this example, the risk coefficient can be 100%-80%=20%. Whether the risk coefficient is defined positively or negatively, an appropriate technical result can be obtained. During implementation, a selection can be made based on actual need. The risk coefficients used as examples can be defined positively or negatively.

In an example regarding identifying document completeness, the risk coefficient can be determined based on the completeness of the identifying documents uploaded by User A. As an example, in the event that the completeness of the uploaded identifying documents is 55% (e.g., only 55% of the required documents are uploaded), then the probability that the uploaded identifying documents will be found acceptable is 55%, and the risk coefficient determined based on the probability of document acceptability is 55%. Please note that the completeness of the identifying documents can be calculated based on the quantity and types of uploaded identifying documents and the quantity and types of identifying documents whose upload was requested.

Regarding identifying document validity, the risk coefficient can be determined based on the validity of the identifying document uploaded by User A. As an example, in the event that the validity of the uploaded identifying document is 68%, then the probability that the uploaded identifying document is to be found acceptable is 68%, and the risk coefficient determined based on the probability of document acceptability is 68%. Please note that document validity can be determined based on whether information in the uploaded document complied with preset requirements (for example, if 68% of the uploaded documents have met the preset requirements such as having valid dates, being in the correct size range, etc.). In other words, the possibility that the document is in the correct size range is 68%, or the possibility that the document matches preset criteria is 68%. In another example, if only 30% of the uploaded documents' statistic data match the preset criteria, the uploaded documents have a high risk of being invalid.

Bioinformation is another piece of information which can be referenced in the event that a user is evaluated. For example, in the event that the information type is biometric information, the risk coefficient corresponding to the biometric information is determined based on: whether a profile picture from the user matches the user's real profile picture, whether voiceprint information from the user matches the user's real voiceprint information, whether fingerprint information from the user matches the user's real fingerprint information, or any combination thereof.

Using User A as an example, the risk coefficient can be determined based on whether a profile picture from User A matches the user. Determining the probability that the uploaded biometric information is acceptable based on a determination of whether the profile picture from User A matches User A (i.e., whether the profile picture from User A is in fact User A according to an image recognition/comparison function that compares the profile picture with an image of the user acquired contemporaneously using the camera on the client device. An example of such an image recognition/comparison function can be a distance function (e.g., a cosine similarity function) or other classifier (e.g., Support Vector Machine (SVM)), and the risk coefficient is determined based on the probability that biometric information is acceptable (e.g., the probability output by the image recognition/comparison function indicating the probability that the profile picture from User A is indeed User A at least meets a prespecified threshold.)

In another example, the risk coefficient can be determined based on voiceprint information from User A. For example, the probability that the uploaded biometric information is acceptable is based on a determination of whether the voiceprint information from User A matches User A (i.e., whether the voiceprint information from User A in fact came from User A according to a voiceprint recognition/comparison function that compares the voiceprint information from User A with a voiceprint of the user acquired contemporaneously using the microphone on the client device. An example of such a voiceprint recognition/comparison function can be a distance function (e.g., a cosine similarity function) or other classifier (e.g., Support Vector Machine (SVM)), and the risk coefficient is determined based on the probability that biometric information is acceptable (e.g., the probability output by the voiceprint recognition/comparison function indicating the probability that the voiceprint from User A is indeed User A at least meets a prespecified threshold.)

In yet another example, the risk coefficient can be determined based on whether fingerprint information from User A matches the user's fingerprint information. For example, the probability that the uploaded biometric information is acceptable is determined based on the determination of whether the fingerprint information from the user matches the fingerprint information from User A (i.e., whether the fingerprint information from User A in fact came from User A according to a fingerprint recognition/comparison function that compares the fingerprint information from User A with a fingerprint of the user acquired contemporaneously using a fingerprint reader on the client device. An example of such a fingerprint recognition/comparison function can be a distance function (e.g., a cosine similarity function) or other classifier (e.g., Support Vector Machine (SVM)), and the risk coefficient is determined based on the probability that the biometric information is acceptable (e.g., the probability output by the voiceprint recognition/comparison function indicating the probability that the voiceprint from User A is indeed User A at least meets a prespecified threshold.)

Permission information can include information relating to blacklists or whitelists. Permission information can mark the user as safe or as considered safe. Therefore, permission information can be used during evaluation. In other words, in the event that the type of information corresponds to permission information, the risk coefficient corresponding to the permission information can be determined based on: whether the user has had predetermined rights restricted, whether the user has had predetermined rights permitted, or both.

Using User A in another example, the risk coefficient can be determined based on whether User A had predetermined rights restricted. For example, whether User A has been denied access to affiliate websites to this website. In the event that the determination determines that User A did not have predetermined rights restricted, then the risk coefficient is greater. In the event that the determination determines that User A had predetermined rights restricted, then the risk coefficient is smaller.

In another example, the risk coefficient can be determined based on whether User A had predetermined rights permitted. In the event that the determination determines that User A did not have predetermined rights permitted (e.g., on affiliate websites to this website) then the risk coefficient is smaller. In the event that the determination determines that User A had predetermined rights permitted, then the risk coefficient is greater.

With the development of big data technology, learning about user behavior is possible, and the user behavior can be used to evaluate a user. For example, in the event that the type of information relates to the user's behavior on the Internet, the risk coefficient corresponding to the behavioral information can be determined based on: information on websites visited by the user, user Internet address information, user operating behavior, or any combination thereof.

Using User A in yet another example, the risk coefficient can be determined based on information about websites visited by User A. In the event that User A has not visited known illegitimate websites or has not visited risky websites known to spread viruses or leak customer information, then the risk coefficient indicates that the user is less risky (the coefficient value can be smaller or greater based on risk coefficient implementation). If User A has visited illegitimate websites or has visited risky websites, the risk coefficient indicates that the user is more risky.

Using User A in yet another example, the risk coefficient can also be determined based on Internet address information (e.g., domain information) of User A. In the event that the Internet address information of User A has not been marked as risky, etc., the risk coefficient indicates that User A is more trust worthy and less likely to be an imposter. In the event that the Internet address information of User A has been marked as risky, etc., the risk coefficient indicates a lower level of trust associated with User A.

Using User A in yet another example, the risk coefficient can also be determined based on the user's operating behavior. In the event that the user's operating behavior on the Internet does not involve risk, the risk coefficient indicates a greater level of risk. In the event that the user's operating behavior on the Internet does involve risk, the risk coefficient indicates a lower level of risk.

In 230, the computer terminal obtains a comprehensive risk coefficient by comprehensively evaluating the risk coefficients corresponding to each type of information.

The comprehensive risk coefficient can be obtained by comprehensively evaluating the risk coefficients corresponding to each type of information.

Using User A in yet another example, User A has uploaded materials such as an identity card, a household register, and a passport. In the event that the expiration date on the identity card has already passed, that means that in the event that User A undergoes an identity card-based identity authentication, the result relates to an identity card authentication failure. In other words, the user's identity cannot be authenticated. In the event that process 200 is used, materials such as the identity card, the household register, and the passport are comprehensively evaluated. The degree to which User A's identity is trusted is evaluated based on information in each of the materials. A comprehensive risk coefficient can be obtained based on the evaluation. In other words, in the event that the expiration date on the identity card has expired, in the event that User A undergoes identity authentication on the Internet, the identity authentication will not necessarily fail because User A's identity undergoes authentication also using other materials including the household register and passport, and the degree to which User A's identity is trusted is comprehensively evaluated. (The risk coefficients corresponding to the collected information used for User A identity authentication are associated with each other to obtain the comprehensive risk coefficient.) Lastly, a determination is made as to whether to authenticate User A's identity. In this case, process 200 also increases the pass rate for identity authentication. The user's experience improves from not having to repeat identity authentication.

In yet another example, the user does not merely upload a series of identifying document photographs. The user can be discovered to be a real-name authenticated guest on a well-known website, such as a social networking site, a job site, etc. The user's real-name authentication on the website serves as one kind of behavioral information on the Internet. To determine the user, the user's comprehensive risk coefficient can be obtained from identifying document photographs and the user's Internet behavioral information.

As an example, three types of information are used by User A for authentication.

The first type of information includes identifying document information. The clarity of the uploaded documents is 80%, and the corresponding risk coefficient is 80%, which indicates that the probability that the user is to be trusted is 80%. The completeness of the uploaded identifying documents is 55%, and the corresponding risk coefficient is 55%, which indicates that the probability that the user is to be trusted is 55%. The pre-assigned weight for clarity of uploaded identifying documents is 0.9, and the pre-assigned weight for completeness of uploaded identifying documents is 0.1. In this case, the risk coefficient corresponding to the identifying document information is 0.8×0.9+0.55×0.1=0.72+0.055=0.772.

The second type of information can include bioinformation. In the event that the user's fingerprint was successfully verified, the corresponding risk coefficient is 100%, which indicates that the probability that the user is to be trusted is 100%.

The third type of information includes the user's Internet behavioral information. Upon acquiring the user's Internet behavioral information, the user can be discovered to be a real-name authenticated user on Website A. A degree to which Website A information is accepted can be 70%. Thus, the corresponding risk coefficient is 70%, which indicates that the probability that the user is to be trusted is 70%.

Pre-assigned weights can be used for comprehensively evaluating identifying document information, bioinformation, and Internet behavioral information. The identifying document information weight can be 0.4, the bioinformation weight can be 0.4, and the Internet behavioral information weight can be 0.2. In this case, the comprehensive risk coefficient is: 0.772×0.4+1×0.4+0.7×0.2=0.3088+0.4+0.14=0.8488.

In the above examples, a higher risk coefficient indicates a higher trust level.

In 240, the computer terminal determines whether to authenticate the user's identity based on the comprehensive risk coefficient. For example, the user's identity is authenticated in the event that the comprehensive risk coefficient satisfies a preset threshold.

The use of the comprehensive risk coefficient to determine whether to authenticate a user's identity avoids the conventional problem, which is each authentication condition-based decision as to whether to authenticate a user's identity is mutually independent and unassociated, results in a greater risk of error during identity authentication decision-making, to the detriment of user experience.

In process 200, multiple types of information on the user awaiting identity authentication are collected, the multiple types of information being used for authenticating the identity of the user; a risk coefficient corresponding to each of the multiple types of information is acquired, the risk coefficient indicating a degree to which the user's identity is trusted; a comprehensive risk coefficient is obtained by conducting a comprehensive evaluation of the risk coefficients corresponding to each type of information; and a determination is made whether to authenticate the user's identity based on the comprehensive risk coefficient. This process 200 thus avoids an otherwise greater risk of error during identity authentication decision-making by associating the risk coefficients corresponding to each type of information and avoiding mutually independent, unassociated identity authentication. The process 200 thereby increases user identity authentication accuracy.

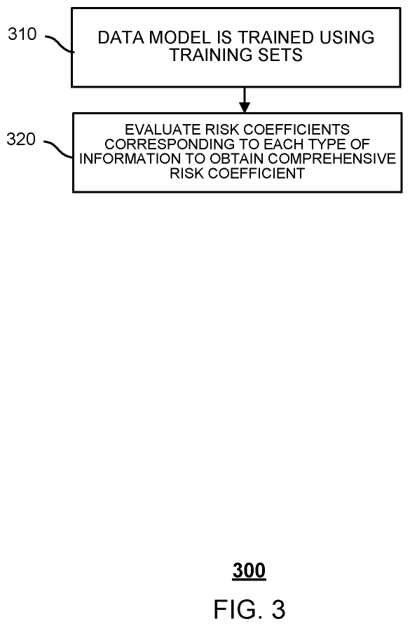

FIG. 3 is a flowchart of an embodiment of a process for obtaining a comprehensive risk coefficient. In some embodiments, process 300 is an implementation of operation 230 and includes:

In 310, a data model is trained using training sets. In some embodiments, the data model implements a machine learning model, such as a support vector machine, a binary classifier, random forests, logistic regression, etc.

In 320, the computer terminal evaluates, based on the data model, the risk coefficients corresponding to each type of information to obtain the comprehensive risk coefficient. In some embodiments, the data model is obtained through training based on training sets. The training sets can include comprehensive risk coefficients corresponding to users having identities that were authenticated, users having identities that failed to be authenticated, or both. The comprehensive risk coefficients corresponding to users having identities that were authenticated, users having identities that failed to be authenticated, or both were obtained from risk coefficients corresponding to each type of information of the users.

The data model can be obtained through training via training sets. The training sets can include comprehensive risk coefficients corresponding to users having identities that were authenticated. The comprehensive risk coefficients corresponding to users having identities that were authenticated can be obtained from risk coefficients corresponding to each type of information of the users. For example, the training sets can include User B1, User B2, User B3, . . . , User Bn as users having identities that were authenticated. In this case, determining, based on the comprehensive risk coefficients of these users, which users can be authenticated is possible.

In some embodiments, to increase the accuracy of the training sets, the training sets can also include comprehensive risk coefficients corresponding to users having identities that failed to be authenticated. The comprehensive risk coefficients corresponding to users having identities that failed to be authenticated were obtained from the risk coefficients corresponding to each type of information of those users. For example, User C1, User C2, User C3, . . . , User Cn are users having identities that failed to be authenticated. The data model is obtained from training via training sets. A comprehensive risk coefficient can be obtained by using a data model to evaluate the risk coefficients corresponding to each type of information. For example, the risk coefficient corresponding to the identifying document information of User A, the risk coefficient corresponding to biometric information, the risk coefficient corresponding to permission information, or any combination thereof are evaluated with the data model to obtain the comprehensive risk coefficient.

Based on process 300, the comprehensive risk coefficient is obtained using a data model to evaluate the risk coefficients corresponding to each type of information. In other words, the risk coefficients corresponding to each type of information are associated to avoid an otherwise greater risk of error in identity authentication decision-making which would occur as a result of mutually independent, unassociated identity authentications, and increase user identity authentication pass rates to enhance the user experience.

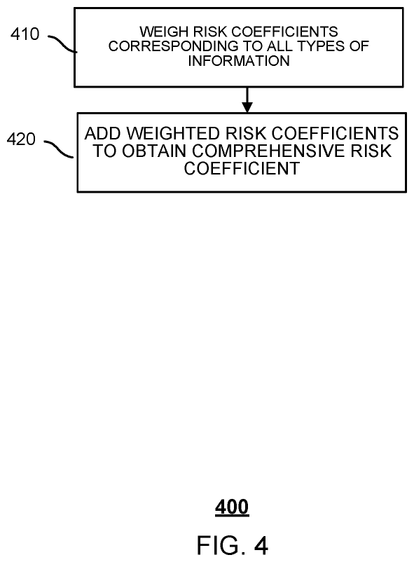

FIG. 4 is a flowchart of an embodiment of another process for obtaining a comprehensive risk coefficient. In some embodiments, process 400 is an implementation of operation 230 and includes:

In 410, the computer terminal weighs the risk coefficients corresponding to all types of information based on the risk coefficients corresponding to each type of information, and obtains the weighted risk coefficients. In some embodiments, a weight corresponding to each type of information corresponds to the effect of that type of information on the comprehensive risk coefficient. In some embodiments, the weight corresponding to each type of information is pre-assigned.

In 420, the computer terminal adds the weighted risk coefficients to obtain the comprehensive risk coefficient.

In some embodiments, each type of information used in identity authentication is pre-assigned a corresponding weight. In some embodiments, each type of information used in identity authentication of multiple users undergoes a process of training and learning to obtain a risk coefficient data model, and the weights corresponding to each type of information are determined based on the risk coefficient data model. In an aspect, the risk coefficients corresponding to all types of information, to obtain weighted risk coefficients, are weighted based on the acquired weights for each type of information, and the comprehensive risk coefficient is obtained based on the weighted risk coefficients.

For example, the weight corresponding to the identifying document information of User A is 0.6, the weight corresponding to biometric information is 0.25, and the weight corresponding to permission information is 0.15. During calculation of the comprehensive risk coefficient, the risk coefficients corresponding to each type of information are weighted respectively according the weight corresponding to identifying document information, the weight corresponding to biometric information, and the weight corresponding to permission information. The sum corresponds to the comprehensive risk coefficient whereby User A's identity is computed.

In the event that process 400 is performed, consideration is given to the influence of the different types of information on user identity authentication. The risk coefficients corresponding to each different type of information are weighted using the weights corresponding to the different types of information, and the sum of the weighted risk coefficients corresponds to the comprehensive risk coefficient. The user's identity authentication risk is further balanced in this way, and the user's experience is further enhanced.

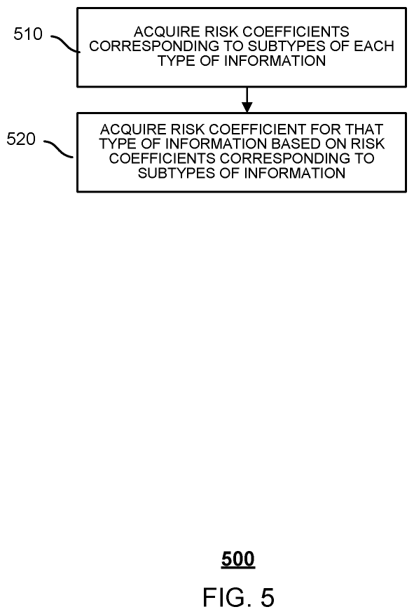

FIG. 5 is a flowchart of an embodiment of a process for acquiring a risk coefficient corresponding to each type of information. In some embodiments, process 500 is an implementation of operation 220 and includes:

In 510, the computer terminal acquires risk coefficients corresponding to subtypes of each type of information. In some embodiments, the risk coefficients corresponding to subtypes include: risk coefficients corresponding to each subtype, risk coefficients corresponding to a combination of at least two subtypes, or both.

Using identifying document information as an example, the subtypes of this type of information include numbers, pictures, expiration dates, and other such information on identifying documents. For example, a risk coefficient corresponding to the identification number on an identifying document is 2, a risk coefficient corresponding to a picture on an identifying document is 3, a risk coefficient corresponding to an expiration date on an identifying document is 1, etc. In another example, the risk coefficient corresponding to the combination of the identification number and picture on an identifying document is 3.5, the risk coefficient corresponding to the combination of the number and expiration date on an identifying document is 2.5, etc.

In 520, the computer terminal acquires the risk coefficient for that type of information based on the risk coefficients corresponding to the subtypes of the type of information.

For example, in the event that the type of information is identifying document information, the subtypes of this type of information include the numbers, pictures, expiration dates, and other such information on identifying documents. For example, in the event that the risk coefficient corresponding to the number on an identifying document is 2, the risk coefficient corresponding to the picture on a document is 3, and the risk coefficient corresponding to the expiration date on a document is 1, then the risk coefficient for the information type based on the risk coefficients corresponding to the information subtypes is 6.

In process 500, the risk coefficients corresponding to each type of information are determined based on the risk coefficients of the subtypes of the different types of information. This process 500 increases the accuracy of acquiring the risk coefficients corresponding to each type of information. The user's identity authentication risk is further balanced, and the user's experience is enhanced.

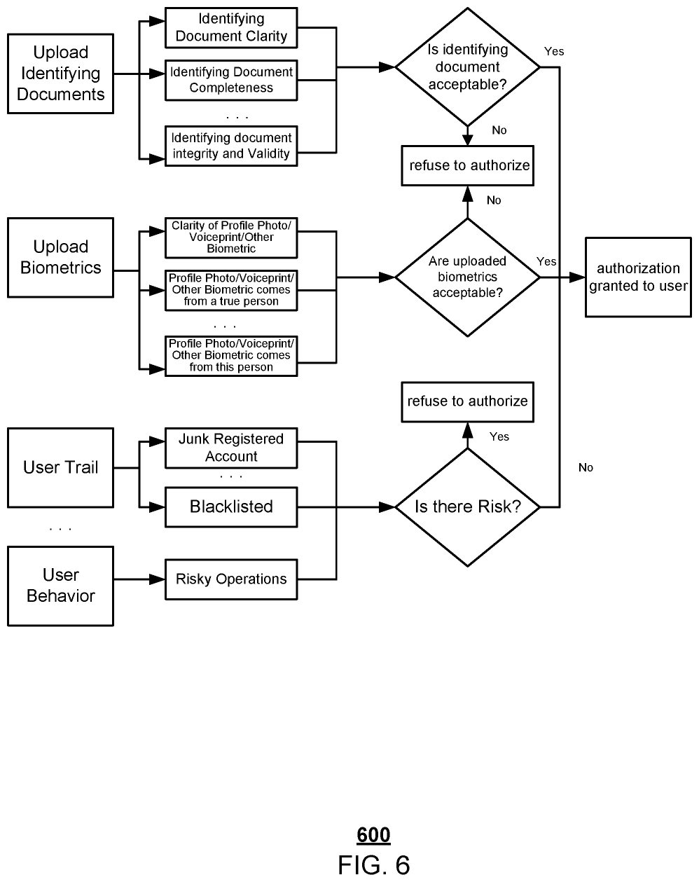

FIG. 6 is a diagram of another embodiment of a process for identity authentication. In process 600, the user undergoes identity authentication using identifying documents, biometrics, user Internet trail, user visit behavior, and other such information uploaded by the user. In the event that the user's identity is authenticated, the user is to be authorized. For example, identifying documents acceptability are determined based on the clarity of the uploaded identifying documents, the completeness of the identifying documents, the integrity and validity of the identifying documents, and other such uploaded information. In the event that the identifying documents are determined to be unacceptable, then requirements are not met, and the user's identity authentication fails, i.e., the user's identity fails to be authenticated. A determination is made whether the clarity of the uploaded profile photograph, voiceprint, another biometric, or any combination thereof is acceptable. In the event that the biometrics are determined to be unacceptable, then the requirements are not met, and the user's identity authentication fails. In other words, the user's identity fails to be authenticated. In some embodiments, a determination is made as to whether a risk exists relating to the user being blacklisted on the Internet or registering a junk account. In the event that a risk exists, then requirements are not met, and the user's identity authentication fails. In other words, the user's identity fails to be authenticated. As an aspect, all of the collected types of user information are analyzed to determine whether the user's identity is to be authenticated and whether authorization is to be granted.

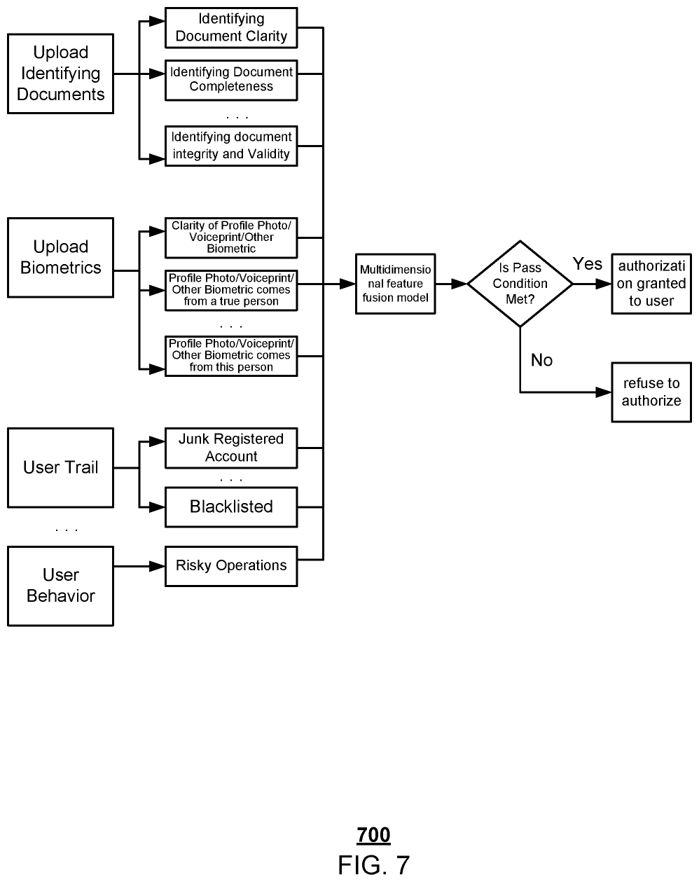

FIG. 7 is a diagram of yet another embodiment of a process for identity authentication. In process 700, the user undergoes identity authentication using identifying documents, biometrics, user Internet trail, user visit behavior, and other such information uploaded by the user. In the event that the user's identity is authenticated, the user is to be authorized. For example, a multidimensional feature fusion model is obtained by uniting information such as uploaded identifying document clarity, identifying document completeness, identifying document integrity, identifying document validity, clarity of profile photographs, clarity of profile voiceprints, other biometrics, risky operations by the user on the Internet, or any combination thereof. All types of information used for user identity authentication are determined based on the multidimensional feature fusion model as to whether the types of information satisfy the conditions for identity authentication. In some embodiments, the multidimensional feature fusion model considers each feature's value and weight. In the event that the types of information satisfy the conditions for identity authentication, the user is granted authorization. In the event that the types of information do not satisfy the conditions for identity authentication, then the user is refused authorization.

The process 700 expands the dimensions of user identity authentication and thus increases satisfaction of the normal user identity authentication experience while covering more risks.

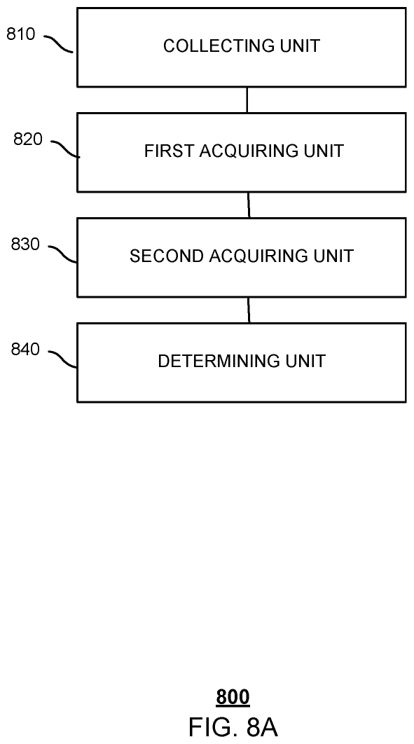

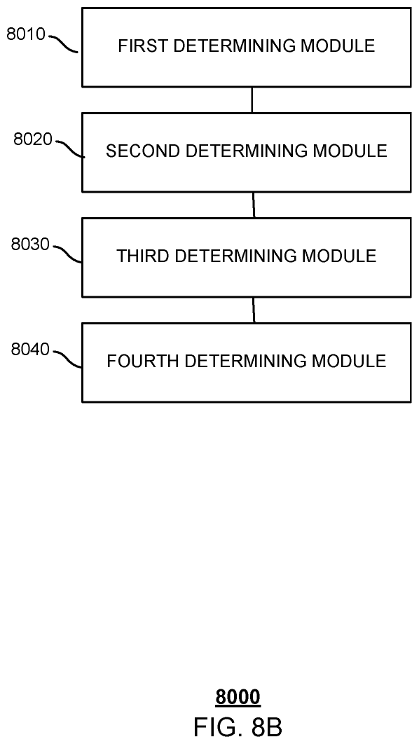

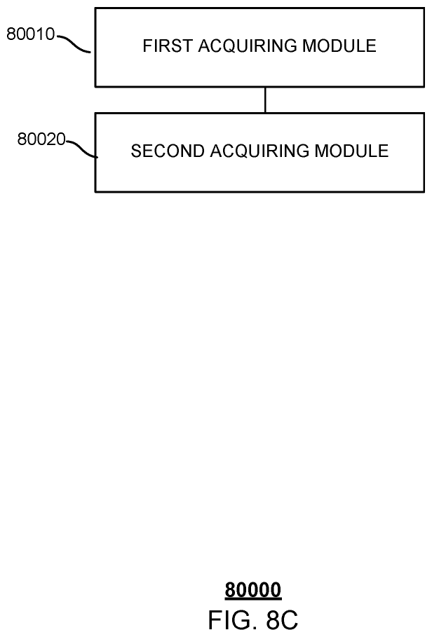

FIG. 8A is a diagram of an embodiment of a device for identity authentication. In some embodiments, the device 800 is configured to implement the process 200 of FIG. 2 and comprises: a collecting unit 810, a first acquiring unit 820, a second acquiring unit 830, and a determining unit 840.

In some embodiments, the collecting unit 810 is configured to collect multiple types of information about a user awaiting identity authentication. In some embodiments, the multiple types of information are used to authenticate the identity of the user.

In many cases, the identity of a user on the Internet is to be authenticated. To authenticate the identity of a user having an identity awaiting authentication, the collecting unit 810 collects multiple types of information for authenticating the identity of the user.

For example, User A (the user awaiting identity authentication) seeks to open a real-name account on a website, and is to have his/her identity authenticated on the Internet. The website is to authorize User A and opens a real-name account for User A only after User A's identity has been authenticated. Typically, User A uploads some User A-related materials to be used for identity authentication on the Internet. In the event that the User A-related materials are uploaded to the Internet to authenticate User A's identity, information is to be collected from the User A-related materials, and this information is to include information for authenticating the identity of User A. Information from the Internet can be collected to be used to authenticate User A's identity. In the event that no User A-related materials are uploaded, then information can be collecting from the Internet that can be used to authenticate User A's identity.

In some embodiments, for device 800, the types of user information includes: identifying document information, biometric information, permission information, user Internet behavior information, or any combination thereof.

Using User A as an example again, the uploaded related materials include: User A's identifying documents, User A's biometric information, or both. As an example, information from the uploaded related materials include identifying document information from the uploaded identifying documents and biometric information from the uploaded User biometric information.

Permission information about User A on the Internet can be used. For example, a determination is made as to whether User A is on an Internet blacklist. In the event that User A is on a blacklist, then User A's rights on the Internet are to be restricted.

Information about User A's behavior on the Internet can correspond to User A's trail of visits on the Internet. For example, User A's visit trail on the Internet can be used to determine whether User A's operations on the Internet are risky.

In some embodiments, the first acquiring unit 820 is configured to acquire a risk coefficient corresponding to each of multiple types of information. In some embodiments, the risk coefficient indicates a degree to which a user's identity is trusted.

The types of user information can include: identifying document information, biometric information, permission information, user Internet behavior information, or any combination thereof.

FIG. 8B is a diagram of an embodiment of an acquiring unit module. In some embodiments, the acquiring unit module 8000 is an implementation of the first acquiring unit module 820 of FIG. 8A and comprises: a first determining module 8010, a second determining module 8020, a third determining module 8030, and a fourth determining module 8040.

In some embodiments, in the event that the type of information is identifying document information, the first determining module 8010 is configured to determine the risk coefficient corresponding to identifying document information based on: identifying document clarity, identifying document completeness, identifying document validity, or any combination thereof.

Please note that risk coefficients can correspond to coefficient values or probabilities. Using User A as an example, the first determining module 8010 determines the risk coefficient based on the clarity of the identifying document uploaded by User A. As an example, in the event that the clarity of the uploaded identifying document is 80%, then the probability that the uploaded identifying document is to be found acceptable is 80%, and the risk coefficient determined based on the probability of document acceptability is 80%. Please note that the clarity of the identifying document can be based on the probability of successfully recognizing information in the identifying document.

In some embodiment, the first determining module 8010 is configured to determine the risk coefficient based on the completeness of the identifying documents uploaded by User A. As an example, in the event that the completeness of the uploaded identifying documents is 55%, then the probability that the uploaded identifying documents is to be found acceptable is 55%, and the risk coefficient determined based on the probability of document acceptability is 55%. Please note that the completeness of the identifying documents can be calculated from the quantity and types of uploaded identifying documents and the quantity and types of identifying documents having been requested for upload.

In some embodiments, the first determining module 8010 is configured to determine the risk coefficient based on the validity of the identifying document uploaded by User A. As an example, in the event that the validity of the uploaded identifying document is 68%, then the probability that the uploaded identifying documents to be found acceptable is 68%, and the risk coefficient determined based on the probability of document acceptability is 68%. Please note that document validity can be based on whether information in the uploaded document complied with preset requirements.

In some embodiments, in the event that the information type is biometric information, the second determining module 8020 is configured to determine the risk coefficient corresponding to the biometric information based on the following conditions: whether a profile picture from the user matches the user, whether voiceprint information from the user matches the user, whether fingerprint information from the user matches the user, or any combination thereof.

Using User A as an example, the second determining module 8020 determines the risk coefficient based on whether a profile picture from User A matches the user. In some embodiments, the probability that the uploaded biometric information is acceptable can be determined based on the determination of whether the profile picture from User A matches User A (i.e., whether the profile picture from User A is in fact User A) and the risk coefficient based on the probability that biometric information is acceptable can be determined.

In some embodiments, the second determining module 8020 determines the risk coefficient based on voiceprint information from User A. As an example, the probability that the uploaded biometric information is acceptable is determined based on a determination of whether the voiceprint information from User A matches User A (i.e., whether the voiceprint information from User A in fact came from User A), and the risk coefficient is determined based on the probability that biometric information is acceptable.

In some embodiments, the second determining module 8020 determines the risk coefficient based on whether fingerprint information from User A matches the user. As an example, the probability that the uploaded biometric information is acceptable is determined based on the determination of whether the fingerprint information from the user matches User A (i.e., whether the fingerprint information from User A in fact came from User A), and the risk coefficient is determined based on the probability that the biometric information is acceptable.

In the event that the type of information is permission information, the third determining module 8030 is configured to determine the risk coefficient corresponding to the permission information based on: whether the user has had predetermined rights restricted, whether the user has had predetermined rights permitted, or both.

Using User A as an example, the third determining module 8030 determines the risk coefficient based on whether User A had predetermined rights restricted. In the event that the determination is that User A has predetermined rights restricted, then the risk coefficient is greater. In the event that the determination is that User A did not have predetermined rights restricted, then the risk coefficient is smaller.

In some embodiments, the third determining module 8030 determines the risk coefficient based on whether User A had predetermined rights permitted. In the event that the determination is that User A has predetermined rights permitted, then the risk coefficient is smaller. In the event that the determination is that User A did not have predetermined rights permitted, then the risk coefficient is greater.

In some embodiments, in the event that the type of information is information about the user's behavior on the Internet, the fourth determining module 8040 is configured to determine the risk coefficient corresponding to the behavioral information based on: information on websites visited by said user, the user's Internet address information, the user's operating behavior, or any combination thereof.

Using User A as an example, the fourth determining module 8040 determines the risk coefficient based on information about websites visited by User A. In the event that User A has visited illegitimate websites or risky websites, then the risk coefficient is greater. In the event that User A has not visited illegitimate websites or risky websites, the risk coefficient is smaller.

In some embodiments, the fourth determining module 8040 determines the risk coefficient based on the Internet address information of User A. In the event that the Internet address information of User A has been marked as risky, etc., the risk coefficient is to be greater. In the event that the Internet address information of User has not been marked as risky, etc., the risk coefficient is to be smaller.

In some embodiments, the fourth determining module 8040 determines the risk coefficient based on the user's operating behavior. In the event that the user's operating behavior on the Internet involves risk, the risk coefficient is to be greater. In the event that the user's operating behavior on the Internet does not involve risk, the risk coefficient is to be smaller.

Referring back to FIG. 8A, in some embodiments, the second acquiring unit 830 is configured to obtain a comprehensive risk coefficient by comprehensively evaluating the risk coefficients corresponding to each type of information.

In some embodiments, the determining unit 840 is configured to determine whether to authenticate the user's identity based on the comprehensive risk coefficient.

In some embodiments, the determining unit 840 determines whether to authenticate a user's identity based on the comprehensive risk coefficient to prevent each authentication condition-based decision as to whether to authenticate a user's identity from being mutually independent and unassociated results in a greater risk of error during identity authentication decision-making, to the detriment of user experience.

Using the example User A, User A has uploaded materials such as an identity card, a household register (special certificate in China), and a passport. In the event that the expiration date on the identity card has already passed, when User A undergoes identity card-based identity authentication, the result is identity card authentication failure. In other words, the user's identity cannot be authenticated. In some embodiments, materials such as an identity card, household register, and passport are comprehensively considered. The degree to which User A's identity is trusted is evaluated based on information in each of the materials. In some embodiments, a comprehensive risk coefficient is obtained through evaluation, and a determination is made whether to authenticate the identity of User A based on the comprehensive risk coefficient. In other words, in the event that the expiration date on identity card has expired, when User A undergoes identity authentication on the Internet, the identity card authentication will not necessarily fail because User A's identity undergoes authentication using other materials such as the household register and passport, and a degree to which User A's identity is trusted is comprehensively evaluated. In some embodiments, the risk coefficients corresponding to the collected information used for User A identity authentication are associated with each other to obtain the comprehensive risk coefficient, and a determination is made as to whether to authenticate User A's identity based on the comprehensive risk coefficient. The use of device 800 can also increase the pass rate for identity authentication, and the user's experience increases from not having to repeat the process of identity authentication.

In some embodiments, for device 800, the collecting unit 810 collects multiple types of information on the user awaiting identity authentication, wherein the multiple types of information are used for authenticating the identity of the user; the first acquiring unit 820 acquires a risk coefficient corresponding to each of the multiple types of information, wherein the risk coefficient indicates the degree to which the user's identity is trusted; the second acquiring unit 830 obtains a comprehensive risk coefficient by conducting a comprehensive evaluation of the risk coefficients corresponding to each type of information; and the determining unit 840 determines whether to authenticate the user's identity based on the comprehensive risk coefficient. This device 800 thus avoids an otherwise greater risk of error during identity authentication decision-making by associating the risk coefficients corresponding to each type of information and avoiding mutually independent, unassociated identity authentication. The device 800 thereby increases user identity authentication accuracy and solves the fact that each authentication condition-based decision as to whether to authenticate a user's identity is mutually independent and unassociated results in a greater risk of error during identity authentication decision-making, to the detriment of user experience.

In some embodiments, in the device 800, the second acquiring unit 830 is further configured to evaluate, using a data model, the risk coefficients corresponding to each type of information to obtain a comprehensive risk coefficient. The data model can be obtained through training based on training sets. The training sets include comprehensive risk coefficients corresponding to users having identities that were authenticated, users having identities that failed to be authenticated, or both. The comprehensive risk coefficients corresponding to users having identities that were authenticated, users having identities that failed to be authenticated, or both were obtained from risk coefficients corresponding to each type of information of the users.

The data model was trained using training sets. The training sets include comprehensive risk coefficients corresponding to users having identities that were authenticated, users having identities that failed to be authenticated, or both. The comprehensive risk coefficients corresponding to users having identities that were authenticated, users having identities that failed to be authenticated, or both were obtained from risk coefficients corresponding to each type of information of those users. For example, the training sets include User B1, User B2, User B3, . . . , User Bn as users having identities that were authenticated, and User C1, User C2, User C3, . . . , User Cn as users having identities that failed to be authenticated. The comprehensive risk coefficient can be obtained by using the data model to evaluate the risk coefficients corresponding to each type of information. For example, the risk coefficient corresponding to the identifying document information of User A, the risk coefficient corresponding to biometric information, the risk coefficient corresponding to permission information, or any combination thereof are evaluated using the data model to obtain the comprehensive risk coefficient.

Using device 800, a comprehensive risk coefficient is obtained by using the data model to evaluate the risk coefficients corresponding to each type of information. In other words, the risk coefficients corresponding to each type of information are associated to avoid an otherwise greater risk of error in identity authentication decision-making which would occur as a result of mutually independent, unassociated identity authentications and increase user identity authentication pass rates and accuracy results, which enhance user experience.

In some embodiments, in device 800, the second acquiring unit 830 is further configured to weigh the risk coefficients corresponding to all types of information based on the risk coefficients corresponding to each type of information and their weights and then perform a calculation to obtain a comprehensive risk coefficient.

In some embodiments, each type of information used in identity authentication is pre-assigned a corresponding weight. In some embodiments, the second acquiring unit 830 subjects each type of information used in identity authentication of multiple users to training and learning to obtain a risk coefficient data model, and the weights corresponding to each type of information are acquired using the risk coefficient data model. In some embodiments, the risk coefficients corresponding to all types of information are weighted based on the acquired weights for each type of information, and a calculation is performed to obtain the comprehensive risk coefficient.

For example, the weight corresponding to the identifying document information of User A is 0.6, the weight corresponding to biometric information is 0.25, and the weight corresponding to permission information is 0.15. During calculation of the comprehensive risk coefficient, the risk coefficients corresponding to each type of information are weighted based on the weight corresponding to the identifying document information, the weight corresponding to biometric information, and the weight corresponding to permission information. The sum of the weighted risk coefficients is the comprehensive risk coefficient whereby User A's identity is authenticated.

Using the device 800, consideration is given to the influence of different types of information on user identity authentication. The risk coefficients corresponding to each different type of information are weighted using the weights corresponding to the different types of information, and the sum of the weighted risk coefficients corresponds to the comprehensive risk coefficient. The user's identity authentication risk is further balanced, and the user's experience is enhanced.

FIG. 8C is a diagram of another embodiment of an acquiring unit module. In some embodiments, the acquiring unit module 80000 corresponds with the first acquiring unit module 820 of FIG. 8A and comprises: a first acquiring module 80010 and a second acquiring module 80020.

In some embodiments, the first acquiring module 80010 is configured to acquire risk coefficients corresponding to the subtypes of each type of information. In some embodiments, the risk coefficients corresponding to subtypes of each type of information include: risk coefficients corresponding to each separate subtype of each type of information, risk coefficients corresponding to a combination of at least two subtypes of each type of information, or both.

In some embodiments, the second acquiring module 80020 is configured to acquire the risk coefficient for the type of information based on the risk coefficients corresponding to subtypes of each type of information.

In the acquiring unit module 80000, the risk coefficients corresponding to each type of information are determined based on the risk coefficients of the subtypes of the different types of information. This increases the accuracy of acquiring the risk coefficients corresponding to each type of information, the user's identity authentication risk is further balanced in this way, and the user's experience is enhanced.

The modules described above can be implemented as software components executing on one or more general purpose processors, as hardware such as programmable logic devices and/or Application Specific Integrated Circuits designed to perform certain functions or a combination thereof. In some embodiments, the modules can be embodied by a form of software products which can be stored in a nonvolatile storage medium (such as optical disk, flash storage device, mobile hard disk, etc.), including a number of instructions for making a computer device (such as personal computers, servers, network equipment, etc.) implement the methods described in the embodiments of the present invention. The modules may be implemented on a single device or distributed across multiple devices. The functions of the modules may be merged into one another or further split into multiple sub-modules.

The methods or algorithmic steps described in light of the embodiments disclosed herein can be implemented using hardware, processor-executed software modules, or combinations of both. Software modules can be installed in random-access memory (RAM), memory, read-only memory (ROM), electrically programmable ROM, electrically erasable programmable ROM, registers, hard drives, removable disks, CD-ROM, or any other forms of storage media known in the technical field.

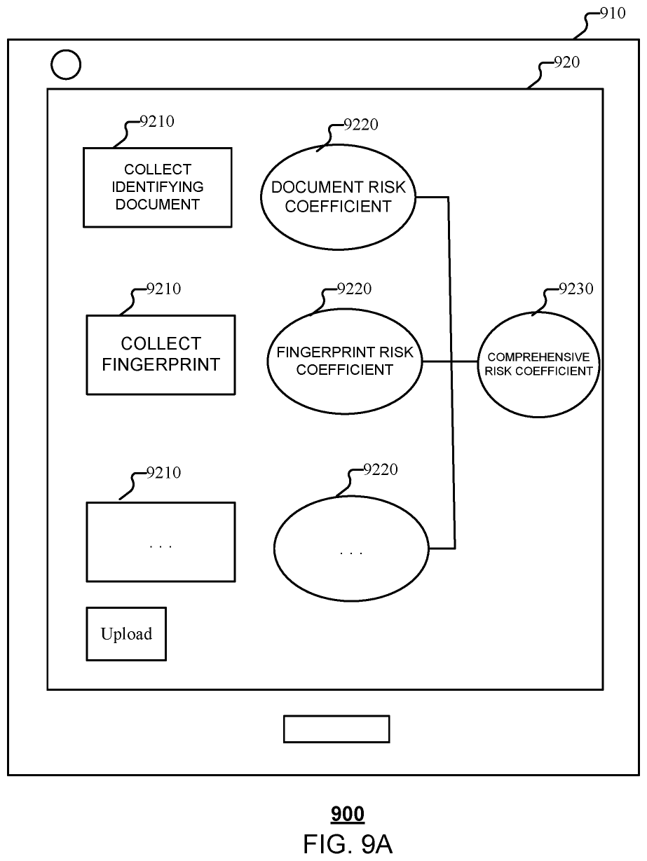

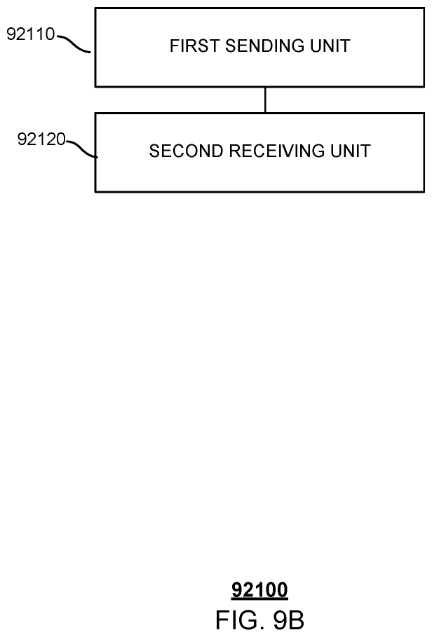

FIG. 9A is a diagram of an embodiment of a system for identity authentication. In some embodiments, the system 900 is configured to implement the process 200 of FIG. 2 and comprises: a computing device 910, which provides a first interface 920.

In some embodiment, the first interface 920 comprises: a plurality of first controls 9210, a plurality of second controls 9220, and a third control 9230.

In some embodiments, the plurality of first controls 9210 are configured to collect multiple types of information on the user awaiting identity authentication, the multiple types of information being for authenticating the identity of the user.

FIG. 9B is a diagram of an embodiment of a first control. In some embodiments, the first control 92100 is an implementation of a first control 9210 of FIG. 9A and comprises: a first sending unit 92110 and a second receiving unit 92120. In some embodiments, the first sending unit 92110 is configured to send multiple types of information to a server, which evaluates the risk coefficients of multiple types of information to obtain a comprehensive risk coefficient. In some embodiments, a risk coefficient corresponds to a degree to which the user's identity is trusted. In some embodiments, the second receiving unit 92120 is configured to receive, from the server, the risk coefficients corresponding to the multiple types of information and the comprehensive risk coefficient.

Referring back to FIG. 9A, in some embodiments, the plurality of second controls 9220 corresponding to the plurality of first controls are configured to generate the risk coefficients corresponding to each type of information.

In some embodiments, the third control 9230 is configured to generate the comprehensive risk coefficient for the user awaiting identity authentication.

The plurality of second controls 9220 can generate the risk coefficients corresponding to multiple types of information, such as the identifying document risk coefficient, the voiceprint risk coefficient, etc.

In some embodiments, the plurality of third controls 9230 generates the comprehensive risk coefficient. This is a technical result that enables the user to view the information and thus further enhances the user's experience.

In some embodiments, the plurality of first controls 9210 authenticates, based on the multiple types of information, a user's identity by collecting the multiple types of information on the user awaiting identity authentication.

Referring back to FIG. 9B, the first sending unit 92110 is configured to send the multiple types of information to a server, which evaluates the risk coefficients of the multiple types of information and thus obtains a comprehensive risk coefficient. In some embodiments, the risk coefficient indicates a degree to which the user's identity is trusted. The second receiving unit 92120 is configured to receive, from the server, the risk coefficients corresponding to multiple types of information and the comprehensive risk coefficient.

Referring back to FIG. 9A, the plurality of second controls 9210 corresponding to the plurality of first controls generate the risk coefficients corresponding to each type of information. In some embodiments, the third control 9230 generates the comprehensive risk coefficient for the user awaiting identity authentication. This approach avoids a greater risk of error during identity authentication decision-making by associating the risk coefficients corresponding to each type of information and avoiding mutually independent, unassociated identity authentication, and this approach increases user identity authentication accuracy. Moreover, the user can view the relevant information by virtue of the second controls generating the risk coefficients corresponding to each type of information and the third control generating the comprehensive risk coefficient for the user awaiting identity authentication. The system 900 avoids authentication condition-based decisions as to whether to authenticate a user's identity being mutually independent and unassociated results in a greater risk of error during identity authentication decision-making, which detriments user experience.

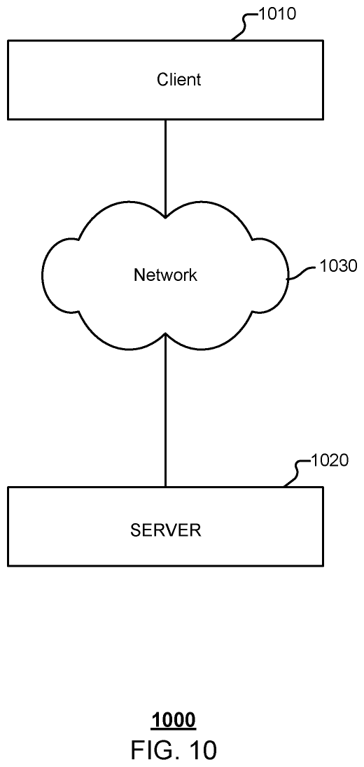

FIG. 10 is a diagram of an embodiment of a system for identity authentication. In some embodiments, the system 1000 includes a client 1010 and a server 1020. The client 1010 and the server 1020 are connected via a network 1030.

In some embodiments, a user using the client 1010 wishes to have their identity authenticated based the server 1020. In some embodiments, the user, via the client 1010 sends multiple types of information on the user to the server. The server 1020 can acquire the risk coefficients corresponding to each of the multiple types of information, wherein a risk coefficient indicates the degree to which the user's identity is trusted, obtain a comprehensive risk coefficient by conducting a comprehensive evaluation of the risk coefficients corresponding to each type of information, and assess whether to authenticate the user's identity based on the comprehensive risk coefficient.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
collecting multiple types of information about a user awaiting identity authentication, wherein the multiple types of information are used to authenticate the identity of the user;
acquiring a plurality of risk coefficients corresponding to respective ones of the multiple types of information, wherein a risk coefficient among the plurality of risk coefficients indicates a degree to which the user's identity is trusted;
obtaining a comprehensive risk coefficient based at least in part on the plurality of risk coefficients corresponding to the respective ones of the multiple types of information; and
determining whether to authenticate the user's identity based at least in part on the comprehensive risk coefficient.

2. The method as described in claim 1, the acquiring of the plurality of risk coefficients comprises:
evaluating, using a data model, the risk coefficients corresponding to the respective ones of information to obtain the comprehensive risk coefficient, wherein:
the data model is obtained through training based on training sets; and
the training sets include comprehensive risk coefficients corresponding to users having identities that were authenticated.

3. The method as described in claim 1, the acquiring of the plurality of risk coefficients comprises:
evaluating, using a data model, the risk coefficients corresponding to the respective ones of information to obtain the comprehensive risk coefficient, wherein:
the data model is obtained through training based on training sets;
the training sets include:
comprehensive risk coefficients corresponding to users having identities that were authenticated; and
comprehensive risk coefficients corresponding to users having identities that failed to be authenticated; and wherein the comprehensive risk coefficients are obtained from risk coefficients corresponding to respective ones of type of information concerning the users.

4. The method as described in claim 1, the obtaining of the comprehensive risk coefficient comprises:
obtaining weighted risk coefficients by weighing the risk coefficients corresponding to the multiple types of information based on the risk coefficients corresponding to the respective ones of the multiple types of information and weights of the respective ones of the multiple types of information; and
obtaining the comprehensive risk coefficient based on the weighted risk coefficients, wherein a weight corresponding to a specific type of information indicates an effect of the specific type of information has on the comprehensive risk coefficient, the weight corresponding to the specific type of information being pre-assigned.

5. The method as described in claim 1, wherein the multiple types of information about the user includes one or more of: identifying document information, biometric information, permission information, and/or Internet behavior information of the user.

6. The method as described in claim 1, wherein:
the multiple types of information about the user includes one or more of: identifying document information, biometric information, permission information, and/or Internet behavior information of the user;
the acquiring of the risk coefficients corresponding to respective ones of the multiple types of information includes:
in the event that the type of information includes identifying document information, determining the risk coefficient corresponding to the identifying document information based on one or more of the following: identifying document clarity, identifying document completeness, and/or identifying document validity;
in the event that the type of information includes biometric information, determining the risk coefficient corresponding to the biometric information based on one or more of: whether a profile picture from the user matches the user, whether voiceprint information from the user matches the user, and/or whether fingerprint information from the user matches the user;
in the event that the type of information includes permission information, determining the risk coefficient corresponding to the permission information based on: whether the user has had predetermined rights restricted, whether the user has had predetermined rights permitted, or both; and
in the event that the type of information includes information relating to the user's behavior on the Internet, determining the risk coefficient corresponding to the behavioral information based on one or more of: information on websites visited by the user, the user's Internet address information, and/or the user's operating behavior.

7. The method as described in claim 1, wherein the acquiring of the risk coefficient corresponding to respective ones of the multiple types of information comprises:
acquiring risk coefficients corresponding to subtypes of a respective one of type of information, wherein the risk coefficients corresponding to the subtypes include: risk coefficients corresponding to respective ones of separate subtype, risk coefficients corresponding to a combination of at least two subtypes, or both; and
acquiring the risk coefficient for that type of information based on the risk coefficients corresponding to the subtypes.

8. A system, comprising:
a processor; and
a memory coupled with the processor, wherein the memory is configured to provide the processor with instructions which when executed cause the processor to:
collect multiple types of information about a user awaiting identity authentication, wherein the multiple types of information are used to authenticate the identity of the user;
acquire a plurality of risk coefficients corresponding to respective ones of the multiple types of information, wherein a risk coefficient among the plurality of risk coefficients indicates a degree to which the user's identity is trusted;
obtain a comprehensive risk coefficient based at least in part on the plurality of risk coefficients corresponding to the respective ones of the multiple types of information; and
determine whether to authenticate the user's identity based at least in part on the comprehensive risk coefficient.

9. The system as described in claim 8, the acquiring of the plurality of risk coefficients comprises to:
evaluate, using a data model, the risk coefficients corresponding to the respective ones of information to obtain the comprehensive risk coefficient, wherein:
the data model is obtained through training based on training sets; and
the training sets include comprehensive risk coefficients corresponding to users having identities that were authenticated.

10. The system as described in claim 8, the acquiring of the plurality of risk coefficients comprises to:
evaluate, using a data model, the risk coefficients corresponding to the respective ones of information to obtain the comprehensive risk coefficient, wherein:
the data model is obtained through training based on training sets;
the training sets include:
comprehensive risk coefficients corresponding to users having identities that were authenticated; and
comprehensive risk coefficients corresponding to users having identities that failed to be authenticated; and wherein the comprehensive risk coefficients are obtained from risk coefficients corresponding to respective ones of type of information concerning the users.

11. The system as described in claim 8, the obtaining of the comprehensive risk coefficient comprises to:
obtain weighted risk coefficients by weighing the risk coefficients corresponding to the multiple types of information based on the risk coefficients corresponding to the respective ones of the multiple types of information and weights of the respective ones of the multiple types of information; and
obtain the comprehensive risk coefficient based on the weighted risk coefficients, wherein a weight corresponding to a specific type of information indicates an effect of the specific type of information has on the comprehensive risk coefficient, the weight corresponding to the specific type of information being pre-assigned.

12. The system as described in claim 8, wherein the multiple types of information about the user includes one or more of: identifying document information, biometric information, permission information, and/or Internet behavior information of the user.

13. The system as described in claim 8, wherein:
the multiple types of information about the user includes one or more of: identifying document information, biometric information, permission information, and/or Internet behavior information of the user;
the acquiring of the risk coefficients corresponding to respective ones of the multiple types of information includes to:
in the event that the type of information includes identifying document information, determine the risk coefficient corresponding to the identifying document information based on one or more of the following: identifying document clarity, identifying document completeness, and/or identifying document validity;
in the event that the type of information includes biometric information, determine the risk coefficient corresponding to the biometric information based on one or more of: whether a profile picture from the user matches the user, whether voiceprint information from the user matches the user, and/or whether fingerprint information from the user matches the user;
in the event that the type of information includes permission information, determine the risk coefficient corresponding to the permission information based on: whether the user has had predetermined rights restricted, whether the user has had predetermined rights permitted, or both; and
in the event that the type of information includes information relating to the user's behavior on the Internet, determine the risk coefficient corresponding to the behavioral information based on one or more of: information on websites visited by the user, the user's Internet address information, and/or the user's operating behavior.

14. The system as described in claim 8, wherein the acquiring of the risk coefficient corresponding to respective ones of the multiple types of information comprises to:
acquire risk coefficients corresponding to subtypes of a respective one of type of information, wherein the risk coefficients corresponding to the subtypes include: risk coefficients corresponding to respective ones of separate subtype, risk coefficients corresponding to a combination of at least two subtypes, or both; and
acquire the risk coefficient for that type of information based on the risk coefficients corresponding to the subtypes.

15. A computer program product being embodied in a tangible non-transitory computer readable storage medium and comprising computer instructions for:
collecting multiple types of information about a user awaiting identity authentication, wherein the multiple types of information are used to authenticate the identity of the user;
acquiring a plurality of risk coefficients corresponding to respective ones of the multiple types of information, wherein a risk coefficient among the plurality of risk coefficients indicates a degree to which the user's identity is trusted;
obtaining a comprehensive risk coefficient based at least in part on the plurality of risk coefficients corresponding to the respective ones of the multiple types of information; and
determining whether to authenticate the user's identity based at least in part on the comprehensive risk coefficient.
